(19) United States
(12) Patent Application Publication
(10) Pub. No.: US 2025/0259329 A1
(43) Pub. Date: Aug. 14, 2025

(54) METHOD FOR DETERMINING A LOCALIZATION OF A SAMPLE BASED ON STRUCTURE INFORMATION

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 19/047,048

(22) Filed: Feb. 6, 2025

(30) Foreign Application Priority Data
Feb. 9, 2024 (DE) 10 2024 103 739.3

(51) Int. Cl. G06T 7/73; G06T 7/00; G06V 10/26; G06V 10/764; G06V 10/774; G06V 20/69; H04N 23/61

(52) U.S. Cl. CPC G06T 7/73; G06T 7/0002; G06V 10/26; G06V 10/764; G06V 10/774; G06V 20/698; H04N 23/61; G06T 2207/10056; G06T 2207/20076; G06T 2207/20081

(57) ABSTRACT

The present disclosure relates to a method for determining a localization of a sample based on structure information, wherein elements of a sample holding device holding the sample in an imaging device form structures in image data captured with the imaging device, comprising providing the image data, determining, by means of a selection model, structure regions based on coarse image data, determining, by means of an identification model, the structure information based on the structure regions, and determining a localization of the sample based on the structure information, characterized in that the coarse image data are reduced in detail compared to the image data, the structure regions are regions in the image data in which the structures are captured with a certain probability and a sum of data quantities of the structure regions is smaller than the data quantity of the image data.

### RELATED APPLICATIONS

This application claims priority to German Patent Application No. DE 10 2024 103 739.3, filed on Feb. 9, 2024, which is incorporated herein by reference in its entirety.

### BACKGROUND OF THE INVENTION

A method for identifying cover glass edges in which a single high-resolution recording of a sample is used in order to search for cover glass edges or similar relevant structures in the high-resolution recording with conventional image analysis tools is known from the prior art. In “Learning to zoom: a saliency-based sampling layer for neural networks”, Recasens, A., et. al., a method is described in which a low-resolution intermediate image of a model is determined on the basis of a high-resolution output image. Relevant or interesting regions are maintained in sufficient resolution in the intermediate image, while the resolutions of irrelevant regions are reduced. In order to be able to capture the regions with different resolutions in the joint intermediate image, an elastic grid which irregularly deforms the high-resolution original image must be estimated. As a result of the irregular deformation, distortions of the geometric properties, in particular of straight and round shapes or objects in a sample, occur in the intermediate image. Furthermore, it is not foreseeable and also not possible to interpret which deformations the model undertakes, which is problematic in particular for previously unseen data.

In practice, it has been found that the finding of cover glass edges, in particular in low-contrast image recordings, poses great challenges to the conventional methods. The analysis of the image recordings is often resource-intensive, time-consuming and data-intensive. For this purpose, it has been found that the analysis is often flawed. This has in particular a poor influence on customer acceptance.

### SUMMARY OF THE INVENTION

The present invention relates to a method for controlling an imaging device based on structure information determined in image data of a sample, a method for training a machine learning system, a machine learning system and a computer program product.

The invention is based on the object of providing an improved method for controlling an imaging device, based on structure information determined in image data of a sample. In particular, the method should be faster, with fewer computing resources, using fewer data resources and furthermore more reliable.

An aspect of the invention relates to a method for determining a localization of a sample, based on structure information, wherein elements of a sample holding device holding the sample in an imaging device form structures in image data captured with the imaging device, comprising providing the image data, determining, by means of a selection model, structure regions, based on coarse image data, determining, by means of an identification model, the structure information, based on the structure regions, and determining a localization of the sample, based on the structure information, characterized in that the coarse image data is reduced in detail compared to the image data, the structure regions are regions in the image data in which the structures are captured with a certain probability, and a sum of data amounts of the structure regions is smaller than the data amount of the image data.

In the sense of the present invention, a “localization” of a sample is just the location of the sample in the sample holding device or in the imaging device or the location of the sample in the sample carrier. These different locations are treated in an equivalent manner, are in each case only different from one another by relative displacements.

In the sense of the present invention, a “sample” is in particular a biological sample. However, the sample can also be any other sample for which the imaging device can be expediently controlled, based on structure information.

In the sense of the present invention, an “imaging device” is in particular a microscope. The microscope is not restricted to certain types of microscopes. In particular, the microscope comprises at least one camera with which image data can be recorded. Alternatively, however, the imaging device can also be any other device for recording samples, in particular biological samples.

In the sense of the present invention, “structural information” is information about the respective sample holding devices, in particular information about the constitution, in particular the physical constitution, of the sample holding devices. In particular, this can be shape information, position information and/or height information. If the sample holding device is, for example, a cover glass, a sample carrier or also a slide, the shape information in particular comprises the information whether the sample holding device is round, square or rectangular. In addition, the structure information can comprise information about the size of the sample holding device and the position of the sample holding device. The position can in particular be determined relative to the sample. Specific standardized object shapes or object geometries are typically known for the different sample holding devices in the prior art, wherein a set of structure information, comprising shape information and size information, is known in particular for each of the object shapes and is determined accordingly. If, in particular, edges are identified in the image data, the structure information can be inferred based on a shape and a size or extent of the edges.

In the sense of the present invention, a “sample holding device” comprises in particular a plurality of parts which together provide the sample in the imaging device. In particular, the parts comprise one or more of cover glasses, sample carriers, labels, spacers and slides, in particular the sample holding device is only partially visible, in particular in particular edges of the cover glasses, sample carriers and the slides are visible.

In the sense of the present invention, “image data” are the data captured by an imaging device. In particular, the terms “image data” and “image” are used synonymously in this application. In particular, the image data can also comprise context information.

In the sense of the present invention, a “camera” can be any camera of an imaging device. If the imaging device is a microscope, the camera can in particular be an overview camera. Alternatively, the camera can also be a microscope camera. The microscope camera can record an overview recording of the sample using an objective with as small a magnification as possible, on the basis of which the structural information can then be determined; alternatively, a plurality of images lying next to one another, so-called tile images, can also be recorded, which are then combined to form an overview image. Possible magnifications comprise, for example, a 1-fold, 2-fold, 3-fold or also 5-fold magnification.

In the sense of the present invention, an “image” is a recording of an imaging device. In particular, in the sense of the present invention, an image can also comprise a plurality of images, in particular image stacks and time series of images or image stacks. In particular, images can also comprise depth information in addition to color information and brightness information. The recording of images can be carried out in the bright field, in the dark field, but also as phase contrast images or the like.

In the sense of the present invention, a “structure region” is a region in the image data in which the structures of the sample holding devices are typically captured or are visible with a certain probability. In particular, the structure regions indicate regions of the image data and of the coarse image data. In particular, the structure regions can first be determined based on the coarse image data and then transmitted or applied to the image data. How exactly a conversion occurs here also depends on how the coarse image data are calculated from the image data. In particular, however, the structure regions can also always be determined with reference to the sample holding device and thus be directly applicable to coarse image data and image data. In particular, the structures in the structure regions in the image data are better than in the structure regions of the coarse image data or are visible or are only visible at all in the image data due to the greater wealth of detail. If the image data are simple images, the structure regions are image sections. If the image data are image stacks, the structure regions are image sections lying one above the other. If the image data are time series of images, the structure regions are respectively image sections at the same point of the images of the time series, identical points of a mapped part of the sample holding device are respectively captured in identical image points of the image sections in the images.

In the sense of the present invention, “coarse image data” are data reduced in detail compared to the image data. In particular, the coarse image data comprises the same region of a sample which was also captured by the image data.

In the sense of the present invention, a “selection model” is a machine learning model which is configured to identify structure regions in the coarse image data. The selection model thus finds in the coarse image data the partial regions in which sample holding devices are at least partially captured with a certain probability.

In the sense of the present invention, an “identification model” is a processing model, in particular a machine learning model, which is configured to identify the structural information. The identification model can be configured as a classical processing model for identifying edges, wherein an edge shape is then determined, for example, on the basis of identified edges. Alternatively, the identification model can also be configured as a machine learning model.

In the sense of the present invention, a “machine learning model” is a processing model, in particular a neural network, which is configured to process input data and to output output data or result data by means of supervised or unsupervised learning and, in particular, can be trained to carry out a specific mapping.

In the sense of the present invention, a “processing model” is a model configured to process input data and to output output data, in particular result data. The processing model can be a classic model which, for example, applies classic optimization or analysis methods or has been created for the application thereof, equally well, the processing model can be a model trained by means of a learning method, it is then referred to as machine learning model. In the case of processing models constructed in a plurality of layers, a distinction is made between output data of intermediate layers and output data of a last layer. The output data of the last, the so-called output layer, are also called result data.

In the sense of the present invention, an “input datum” is a datum input into a processing model, which is processed by the processing model. In the present invention, input data are in particular image data. The input data can in particular comprise an individual image or a plurality of images, image stacks or time series of images or image stacks.

In the sense of the present invention, a “result datum” is a datum output by a processing model, which is calculated and output by processing the input datum by the processing model.

In a multi-layer model, a last layer of the model, the so-called output layer, also called result layer, outputs the result data.

In the sense of the present invention, an “output datum” is a datum output by a processing model, wherein the processing model can output in particular a plurality of output data, in particular a result datum. In addition to the result datum, a processing model can also output one or more intermediate data.

In the sense of the present invention, a “convolutional network” is a neural network with convolutional layers. In particular, the network can also comprise pooling layers, non-linear layers and other known layers in addition to the convolutional layers. The arrangement of the layers is defined in the network architecture.

In the sense of the present invention, an “intermediate layer” is a layer which receives input data from a preceding layer in a machine learning model, in particular a network or a neural network, and forwards output data to a subsequent layer of the network.

In the sense of the present invention, an “intermediate data”, also called intermediate output or intermediate layer output, is an output of a multi-layer processing model of a layer which is not the last layer of the processing model, that is to say of an intermediate layer.

In the methods known from the prior art for determining a localization of a sample, based on identified structure information, in particular an identification of glass edges and the shape thereof, either special illumination devices are required in order to reliably identify glass edges, or the images recorded by the glass edges have to be analyzed with a large computational cost and memory outlay. The analysis of the images is very time-consuming for this purpose. Despite the complex analyses, the results are often flawed. This has a considerably negative influence on the customer acceptance of such automatic systems for sample localization. The inventors have recognized that a large part of the image data is irrelevant for the finding of the structure information, and have therefore proposed firstly determining, by means of the selection model, the structure regions relevant for the finding of the sample, based on the coarse image data, which are significantly reduced in detail compared to the image data. Due to the fact that the coarse image data reduced in detail are used, the selection model has to analyze a significantly smaller data amount, which significantly accelerates the analysis and consumes fewer computing resources. Furthermore, the use of the coarse image data reduced in detail increases the data efficiency during the training of the selection model quite significantly, since the coarse image data show fewer details and the selection model therefore has to learn fewer details during the training, which is why fewer training data are required for the complete training. Furthermore, the reduction in detail ensures that the selection model is not trained on slightly visible, small details, but instead a semantics, also referred to as context, of the images to the effect that large structures are identified in the images and the structure regions can be identified according to the large structures in the image data. In fact, the sample holding devices in the samples under consideration are always at similar positions relative to these large structures, wherein the said large structures are in particular to be found at different locations in the image data, depending on the imaging device. For the actual finding of the structures for determining the structure information, the image data, that is to say the image data true to detail, are then required again. Here, however, only those parts of the image data which are identified as structure regions are processed by the identification model, which thus also has to process a significantly smaller data amount of the image data in the structure regions, since the structure regions make up only a small proportion of the image data. The method described thus achieves a further reduction of the required computing resources, storage resources and a reduction of the waiting time for the user. In addition, the structure regions can be analyzed with the full detail fidelity, as a result of which an accuracy is improved in the determination of the structure information. A processing of the image data, which were not identified as structure regions, is not required.

The image data preferably comprises in particular images captured by a camera of the imaging device, in particular one or more of the following: a temporal sequence of images, an image stack, a stereo image, an image with depth information, an image with a low contrast, or an image captured with an objective with a small magnification.

As a result of the fact that the method can be applied to many different types of image data, the disclosed method can be applied to the image data of many different imaging devices.

Preferably, the coarse image data exhibits in particular one or more of the following over the image data: a lower sampling depth, a lower image resolution, a lower temporal resolution, a lower resolution along a height, in particular a greater distance of neighboring images of a stack.

As a result of the fact that the reduction in detail can be carried out in different ways, a suitable reduction in detail can be selected in particular according to a context of the respective sample which indicates or reproduces the large structures to be identified or to be recognized.

Preferably, the sample holding device comprises one or more elements, in particular slide, cover glass, spacer, sample carrier, holding frame, inscriptions, markings or labels, wherein structures of the sample holding device captured in the image data are visible in particular as light or dark lines, light or dark arcs, circular arcs or circles, so-called blobs, particularly light or dark image areas, so-called spots, distortions, mirroring, doubling, textures or characters.

In the sense of the present invention, an “element” is a component or a plurality of components of the sample holding device which forms or form a structure or structures in the image data during capturing with the imaging device. In particular, the elements can depend on a position in the imaging device, on the different elements of the sample holding device and on an illumination of the imaging device, depending on the imaging device used.

Preferably, the structure information in particular comprises information about geometry, orientation and/or position of the structure, in particular whether the structure is straight or round.

As a result of the fact that very different sample holding devices and their respective shape and size can be determined, the method can be applied for very different imaging devices.

The method preferably comprises determining coarse image data based on the image data, and in particular determining structure regions in the coarse image data, and selecting the structure regions of the image data corresponding to the structure regions of the coarse image data, wherein the structure regions corresponding to one another capture the same elements of the sample holding device.

Since the coarse image data and the image data each capture the same image regions, the structure regions between the coarse image data and the image data can be determined particularly simply. As a result of the fact that the structure regions are first determined on the coarse image data, a lot less data have to be processed by the selection model, which improves the data efficiency.

The selection model is preferably a machine learning model implemented as classifier, detector, segmentation model or image-to-image model, and the determining of the structure regions comprises inputting at least one partial region of the coarse image data as input data into the selection model, outputting an output datum, and in particular selecting the structure regions from the coarse image data based on the output datum.

In the sense of the present invention, a “classifier”, also called classification model, is a processing model which assigns a class to an input datum or can be trained to assign a class to the input datum. The classifier can in particular be a machine learning model. The result datum can in particular be a class assigned to the input datum, wherein the format can in particular be a vector, wherein each entry of the vector corresponds precisely to one of the possible classes to be assigned, and in particular a “1” entry in the vector indicates the class of the input datum. Alternatively, a class number can be output. As a further alternative, however, the classifier can also be trained such that the result datum is a vector, wherein the entries in the vector respectively indicate a probability that the respective input datum belongs to the class corresponding to the entry of the result datum. Depending on an implementation, the respective format of the result datum varies by classifiers and correspondingly also the format of the target datum in an annotated data set for training the classifier.

In the sense of the present invention, a “detector”, also called detection model, is a machine learning model which has been trained to identify predetermined detection patterns in input data and to output a list. In particular, the list is a list of localizations, for example a localization in the input data. The input data can in particular be an image, an image stack or else an input tensor. The exact format of the localization depends in particular on the format of the input data and the detection patterns to be identified.

In the sense of the present invention, a “segmentation model”, also called semantic segmentation model or semantic segmenter, is a processing model which assigns an output value to each entry of an input datum; a result datum is also referred to as a segmentation mask or semantic segmentation mask. If the input datum is an image, the segmentation model carries out an image-to-image model with which an output value corresponding to a semantics is assigned to each image point of an input datum.

In the sense of the present invention, an “image-to-image model” is a processing model which is configured to carry out an image-to-image mapping. The image-to-image model assigns a value in the output datum to each entry of an input datum.

In the sense of the present invention, an “annotated data set” comprises input data and target data, wherein an annotation or identification, called target datum, of the target data corresponds to each input datum of the input data. The target data are typically generated by complex processing or by manual marking. A processing model for executing a desired mapping is trained on the basis of the target data.

In the sense of the present invention, a “target datum” is a datum used in the training of a processing model for executing a processing mapping, to which a result datum output by the processing model based on the input datum is to be adapted. The approximation is carried out with the aid of an objective function.

In the sense of the present invention, an “objective function” is in particular a gain function or a loss function which specifies how differences between the result datum of the processing model and the target datum are evaluated. In the training of machine learning models, the training is carried out by optimizing the objective function, wherein the model parameters of the trained machine learning model are adapted during the training such that the objective function is optimized.

In the sense of the present invention, a “gain function” is an objective function, wherein, in contrast to the loss function which captures a difference between result datum and target datum and is minimized in the course of the training, the gain function captures a match and maximizes the match in the course of the training.

In the sense of the present invention, a “loss function” is a function which captures differences between the result datum and the predefined target datum. If the result datum and the target datum are images, for example, the comparison can be carried out pixel by pixel. If the result datum and the target datum are vectors or tensors, for example, the difference can be carried out entry by entry. The differences can be added in absolute value (as absolute values) in an L1 loss function. The square sum of the differences is formed in an L2 loss function. To minimize the loss function, the values of model parameters of the processing model are changed, which can be calculated, for example, by gradient descent and back propagation. Further possible loss functions are in particular a cross-entropy loss, a hinge loss, a logistic loss, a log-likelihood loss, a Gaussian negative log-likelihood loss or a Kullback-Leibler loss.

In the sense of the present invention, “model parameters” are parameters of a machine learning model which determine the calculation of an output value from an input value of the machine learning model. In the training of the machine learning model, the model parameters of the machine learning model are adapted such that the output of the machine learning model matches the desired output as well as possible, i.e. that the result data match the target data as well as possible. The machine learning model learns a desired mapping by suitable adaptation of the model parameters.

By virtue of the fact that the selection model is implemented as a machine learning model, the image analysis can be carried out particularly efficiently by the selection model, in particular, for example, on special graphics cards provided for this purpose or special processors for calculations of neural networks or similar machine learning models.

The selection model is preferably a classifier and the result datum comprises a class assignment of the input datum to result classes, and the selecting of the structure regions is performed based on the result classes, the result classes comprising one or more of the following classes: structure class, non-structure class, label class, non-sample class, and the structure regions are precisely the image regions assigned to the structure class. In particular, the classifier can be a binary classifier with the classes structure class and non-structure class.

As a result of the fact that the selection model can be implemented differently, the method can be optimized for specific purposes depending on the specifications. If in particular a particularly exact determination of the structure regions is required, an image-to-image model is preferably used which outputs probability maps, on the basis of which the structure regions can be determined extraordinarily exactly. In the training of such image-to-image models, the generating of the target data is admittedly more complex, but the structure regions can be determined extraordinarily well for this purpose. If instead a simple classifier is used, then the annotation is correspondingly less complex.

The classifier is preferably a regular classifier or a patch classifier, wherein the input datum of the regular classifier are the coarse image data, the result datum comprises a classification map, wherein the respective result class is respectively assigned to the partial regions of the coarse image data in the classification map, and the input data of the patch classifier are respectively partial regions of the coarse image data, which are successively selected by means of a sliding window function, and the respective result class is output as result datum for each of the partial regions.

In the sense of the present invention, a “sliding window function” is a function which respectively successively selects a partial region, also referred to as partial data set, of a data set corresponding to the size of the sliding window from the data set and provides it for further processing. In this case, the sliding window can be in particular a one-dimensional sliding window, a two-dimensional sliding window or a three-dimensional sliding window. The sliding window function respectively selects spatially and/or temporally coherent data from the respective data set. If a first partial data set is selected and provided, the sliding window is shifted further by a number of entries, a step size, in the data set and then the next sliding window is provided for further processing.

Since the coarse image data are divided into the actual result class and the non-result class, the structure regions can be selected from the coarse image data in a simple manner based on the result class.

The regular classifier is preferably configured such that a last pooling layer is omitted, such that the regular classifier outputs the classification map as result datum.

The regular classifier in which the last pooling layer is omitted is also referred to as map classifier according to the present invention. Since the selection model is implemented as map classifier, the coarse image data only have to be input into the selection model once, and the result data then provide result classes for all image regions of the input data.

The selection model is preferably a neural network, in particular one or more of: a fully convolutional network, in particular a DenseNet, a Resnet or a ResNext.

The selection model is preferably implemented as detector and the result datum comprises a list with data localizations by means of which the structure regions are selected from the image data.

As a result of the fact that the selection model is implemented as detector, the structure regions can be determined in a particularly simple manner by means of the list output by the detector.

The selection model is preferably implemented as a segmentation model and the output datum is a segmentation mask in which a result class is assigned to each entry of the input datum, which indicates whether the respective entry belongs to a structure region or not.

In the sense of the present invention, a “segmentation mask” is an output datum of a machine learning model in which an output value is assigned to each entry of an input datum. The output value can in particular correspond to an assigned class.

As a result of the fact that the selection model is implemented as segmentation model and outputs a segmentation mask, the result can be checked in a particularly simple manner, for example by superimposing segmentation mask and image data, an operator can quickly and simply check the segmentation mask for consistency, for example, and thus quickly create an annotated data set.

The selection model is preferably configured as image-to-image model, wherein the output datum is a probability map in which a probability value, in particular a probability distribution, is assigned to entries of the input datum, which indicates the probability with which a structure is captured at the location of the entry, in particular a probability value is assigned to each entry or respectively to a group of entries, and the determining of the structure regions comprises a grouping of entries of the image data based on the probability, wherein in particular continuous entries of the image data are combined with probability values above the certain probability to form a structure region or form a structure region.

In the sense of the present invention, a “probability map” indicates a probability that a sample holding device was captured at the respective point in the image data. In particular, a confidence map can be determined from a probability map.

As a result of the fact that the selection model is implemented as image-to-image model which outputs probability maps, the image data to be processed further can be changed in a particularly simple manner during further processing, for example by changing the certain probability.

If the selection model is implemented as image-to-image model or segmentation model, the selection model is, for example, a Unet or an encoder-decoder network.

Preferably, the determining of the structure information comprises inputting the structure regions of the image data into the identification model according to an order, wherein the order is determined based on the probability values of the structure regions, in particular structure regions with higher probability values are classified in the order before structure regions with lower probability values and the inputting of the structure regions in particular aborts as soon as a certain number of structure information have been determined or only a predetermined number of the structure regions with the highest corresponding probability values are input into the identification model and the further structure regions with lower probability values are no longer input into the identification model.

As a result of the fact that the structure regions are processed according to their respective probability values, the computation efficiency can be further improved, since it is to be expected that the structure regions with higher probability values provide better results during the further processing with the identification model.

The identification model is preferably implemented as classifier, segmentation model, detector or as image-to-image model.

The identification model is preferably implemented as classifier, a result datum of the classifier in particular comprises a shape class, and the structure information is determined based on the shape class, wherein the shape classes in particular comprise one or more of: no structure, structure, round structure, straight structure, polygonal structure, straight cover glass edge, polygonal cover glass edge, round cover glass edge, sample carrier edge, spacer structure, holding frame structure, Microtiter plate edge structure, Microtiter plate well structure, sample chamber edge structure, sample chamber structure.

Since a classifier is used as identification model, the creation of an annotated data set is particularly simple.

The identification model is preferably implemented as classifier, wherein a result datum of the classifier comprises an element class, and the structure information is determined based on the assigned element class, wherein a type of the possible elements of the sample holding device is in particular assigned to each of the element classes.

As a result of the fact that the identification model is implemented as classifier which outputs an element class, the localization of the sample can be determined particularly simply based on the respectively identified element.

The identification model is preferably implemented as a segmentation model and the result datum comprises a segmentation mask of the respective structure region, in which a shape class is assigned to each entry of the input datum, the structure information is determined based on the segmentation mask, and the shape classes in particular comprise one or more of the following classes: no structure, structure, round structure, straight structure, polygonal structure, straight cover glass edge, polygonal cover glass edge, round cover glass edge, sample carrier edge, spacer structure, holding frame structure, Microtiter plate edge structure, Microtiter plate well structure, sample chamber edge structure, sample chamber structure.

As a result of the fact that the identification model is implemented as segmentation model, the granularity of the shape class in the image data is considerably improved, for which reason the structure information can be determined even more exactly based on the shape classes. This applies in particular when merging the structure information.

The image data preferably comprise a plurality of overview images, a plurality of structure regions are determined in the overview images, and the localization of the sample is determined on the basis of the plurality of segmentation masks determined on the basis of the structure regions.

In the sense of the present invention, an “overview image” is an image which was recorded with an overview camera or an image which was recorded with a microscope camera using an objective with a small magnification. In this case, the overview image captures in particular one or more of the sample, the sample carrier and a sample holding device.

As a result of the fact that a plurality of overview images are determined, the sample can be localized better. In particular, gaps in the segmentation masks can be filled by merging segmentation masks, which improves the accuracy in the localization.

The result data output for the different structure regions is preferably merged together with the remaining image data to form reduced-detail result data, the respective result data being assigned to the structure regions, and the value of the non-structure shape class being assigned to the entries of the remaining image data, and the localization being determined on the basis of the reduced-detail result data.

The localization can be verified particularly simply by combining a plurality of segmentation masks.

The identification model is preferably configured as an image-to-image model, wherein a value is assigned to each entry of the input datum in the result datum, which indicates whether the respective entry captures a structure or not, wherein the value in particular is a probability, and in particular the result datum is a probability map, in particular the probability value can also be a probability distribution over a plurality of shape classes.

As a result of the fact that the identification model outputs a probability map, the result datum can be verified particularly well and illustrative. Furthermore, the information content in a probability map is higher, wherein, in particular during the further processing of probability distributions, the result directly provides a statement about the quality of the assignment, which can also be taken into account during the further processing and thus further improves the reliability of the correct result, i.e. to find the localization of the sample at the end.

The determining of the localization preferably comprises merging structure information from a plurality of source-identical structure regions from different overview images, wherein one or more structures which have each been caused by the same element of the sample holding device are captured in the source-identical structure regions.

As a result of the fact that the different structure information of source-identical structure regions are merged, the reliability of the entire method can be further improved.

The identification model is preferably a neural network, in particular one or more of: a fully convolutional network, in particular a DenseNet, a Resnet or a ResNext.

The selection model and/or the identification model are preferably selected from a list of machine learning models, respectively based on the imaging device, the sample holding device used, the sample carrier 106 used and in particular based on an overview camera used.

As a result of the fact that the different machine learning models are respectively selected based on a configuration of the image data evaluation system, specific machine learning models which function very well can be respectively provided, which considerably improves the quality of the results.

Context information is preferably used in determining the structure regions, in determining the structure information or also in determining the localization.

In the sense of the present invention, “context information” comprises one or more of:
information about available and/or used light sources and/or their exposure spectra,
information about available and/or used light source filters and/or their chromatic properties during the spectral filtering of the illumination spectrum of the light source,
information about available and/or used fluorescence filters for spectrally filtering the fluorescence spectrum emitted by the sample,
information about available and/or used dichroic mirrors and their chromatic properties,
an illuminance of the light source,
an illumination time of the light source,
a type of the recorded sample, the sample holding device or the imaging device,
a type of sample carrier which was used, for example whether a chamber slide, a microtitre plate, a slide with cover glass or a Petri dish was used,
image recording parameters, such as, for example, information about illuminance, illumination time, filter settings, fluorescence excitation, contrast method, or sample table settings,
information about objects contained in the respective overview image,
application information which indicates for which type of application the overview images were recorded,
information about a user who has recorded the images of the sample.

A further aspect of the invention relates to a method for controlling an imaging device for capturing a sample, based on the localization of a sample, wherein the localization has been determined according to the method described above, the method further comprising controlling the imaging device, based on the determined localization.

As a result of the fact that the localization of the sample is determined automatically, the sample can thereafter be analyzed completely automatically, as a result of which a throughput can be increased.

A further aspect of the invention relates to a method for training a selection model for determining object regions based on coarse image data, wherein the selection model is in particular trained for carrying out the method described above, comprising providing image data, determining structure regions in the image data, determining coarse image data reduced in detail compared to the image data, determining object regions corresponding to the structure regions, providing the coarse image data as input data and target data, on the basis of which the structure regions can be identified, of an annotated data set for training the selection model.

As a result of the fact that the annotated data set can be determined automatically, a selection model can correspondingly be trained quickly and reliably in a simple manner even for new image data evaluation systems.

A further aspect of the invention relates to a control apparatus for controlling an image data evaluation system, which is in particular designed as a microscope, comprising means for carrying out the method described above.

A further aspect of the invention relates to a computer program product comprising instructions which, when the program is executed by one or more computers, cause the latter to carry out the method described above.

A further aspect of the invention relates to an imaging device, in particular designed as a microscope, comprising the control apparatus described above.

A further aspect of the invention relates to an image data evaluation system comprising at least the imaging device described above.

### BRIEF DESCRIPTION OF THE DRAWINGS

The invention is explained in more detail below on the basis of the examples illustrated in the drawings. The drawings show in:

FIG. 1 schematically a system for use with a method according to one embodiment;

FIG. 2A schematically parts of the system for use with a method according to one embodiment;

FIG. 2B schematically parts of the system for use with a method according to one embodiment;

FIG. 2C schematically parts of the system for use with a method according to one embodiment;

FIG. 3 schematically image data for use in a method according to one embodiment;

FIG. 4 schematically parts of the system for use with a method according to one embodiment;

FIG. 5 schematically parts of the system for use with a method according to one embodiment;

FIG. 6 schematically a machine learning model for use with a method according to one embodiment;

FIG. 7 schematically an arrangement of parts of the system for use with a method according to one embodiment,

FIG. 8 schematically a method according to one embodiment;

FIG. 9A schematically an arrangement of parts of the system for use with a method according to one embodiment;

FIG. 9B schematically an arrangement of parts of the system for use with a method according to one embodiment;

FIG. 9C schematically an arrangement of parts of the system for use with a method according to one embodiment;

FIG. 10 schematically a method according to one embodiment;

FIG. 11 schematically a method according to one embodiment.

### DETAILED DESCRIPTION OF THE EMBODIMENTS

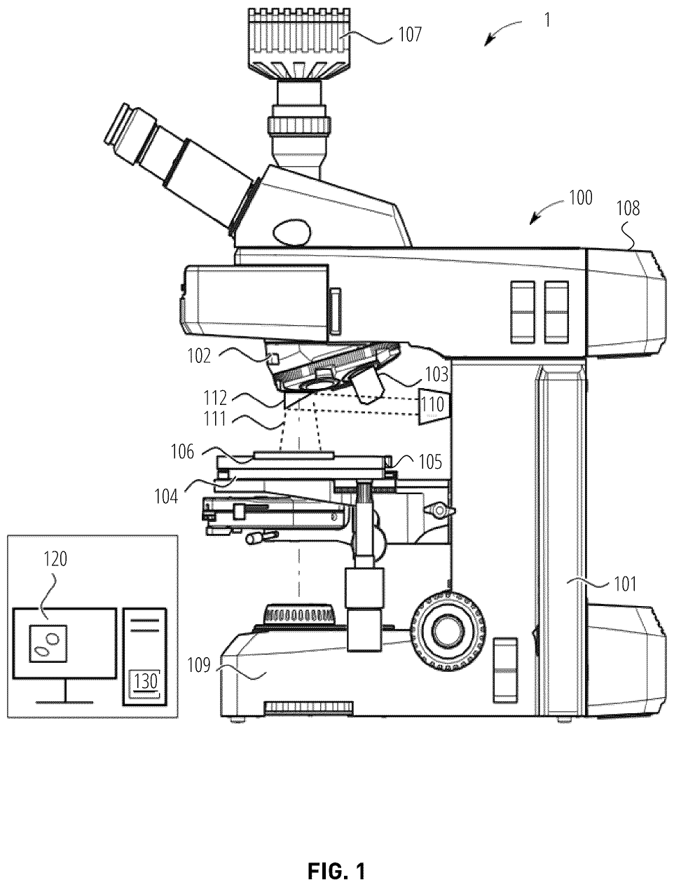

An exemplary embodiment relates to an image data evaluation system 1. The image data evaluation system 1 comprises an imaging device 100, which can in particular be a microscope, and a control apparatus 130, also called evaluation and control apparatus. The control apparatus 130 can in particular be connected to a monitor 120. The control apparatus 130 is communicatively coupled to the imaging device 100 (for example in a wired or wireless communication link). The control apparatus 130 can evaluate image data 500 captured using the microscope 100 (see FIG. 1) and control the imaging device 100, for example, based on the evaluated image data 500. If the image data evaluation system 1 comprises a machine learning model, for example a neural network, it is also referred to as a machine learning system.

The image data evaluation system 1 is configured in particular for automatic evaluation, in particular for determining a localization 202 of a sample, based on structures 312 contained in overview images 300 recorded from the sample.

The imaging device 100 according to the illustrated embodiment is a light microscope. The microscope 100 comprises a stand 101 which comprises further microscope components. The further microscope components are in particular an objective changer or turret 102 with a mounted objective 103, a sample stage 104 with a holding frame 105 for holding a sample carrier 106, also called sample holder, and a microscope camera 107. The combination of sample stage 104 with holding frame 105 and sample carrier 106 is also referred to as sample storage device. The sample holding device can in particular also comprise a cover glass and a spacer.

If a sample is clamped into the sample carrier 106 and the objective 103 is pivoted into the microscope optical path, a fluorescence illumination device 108 can illuminate the sample for fluorescence recordings, the microscope camera 107 can receive the fluorescence light as detection light from the clamped sample and can record image data 500 in a fluorescence contrast. If the microscope 100 is to be used for transmitted light microscopy, a transmitted light illumination device 109 can be used in order to illuminate the sample. The microscope camera 107 receives the detection light after passing through the clamped sample and records image data 500. Samples can be any objects, fluids or other microstructures, in particular biological microstructures.

The microscope 100 optionally also comprises an overview camera 110 with which overview images of a sample environment can be recorded. The overview images show in particular the sample holding device, comprising the sample carrier 106. A field of view 111 of the overview camera 110 is larger than a field of view during a recording of image data 500 with the microscope camera 107. In particular, the overview camera 110 looks at the sample holding device by means of a mirror 112. The mirror 112 is arranged on the objective turret 102 and can be selected instead of the objective 103.

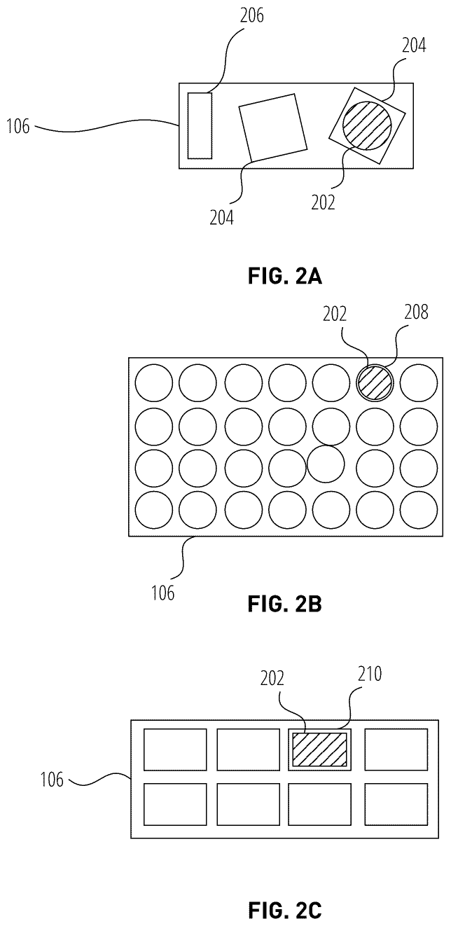

According to some embodiments of the present invention, different sample carriers 106 can be used in the microscope 100. In particular, simple sample carriers 106, also referred to as slides, can be used in which the sample is arranged on a glass plate. Furthermore, there are also sample carriers 106 in which the sample is arranged between the abovementioned glass plate of the sample carrier 106 and a cover glass 204. Such a sample carrier 106 is illustrated schematically in FIG. 2A. Here, a localization 202 of the sample is illustrated by way of example in a hatched manner. For the sake of clarity, the localization 202 is illustrated only for one of the two samples respectively arranged under a cover glass 204. There are many different models and types of sample carriers 106 which are known to the person skilled in the art and for which the person skilled in the art also knows the usual localization 202 of the sample in the respective sample carrier 106.

In addition, sample carriers 106 can also have a label 206, likewise illustrated schematically in FIG. 2A. The label 206 can be used in particular for identifying the sample; for example, barcodes or else QR codes or else handwritten markings are used for this purpose. The label 206 can likewise be identified and analyzed when recording an overview image 300. Instead of the label 206, a barcode or a QR code can also be printed directly on the sample carrier 106 without a label 206 being provided for this purpose on the sample carrier 106.

FIG. 2B illustrates a further type of sample carrier 106. The sample carrier 106 in FIG. 2B is a so-called microtitre plate, also called multiwell dish. Such microtitre plates comprise a plurality of wells 208 which are generally arranged regularly, the sample is arranged here within the wells 208, for which reason the localization 202 approximately corresponds here to the wells 208. A number of wells 208 and the size of the wells 208 can vary greatly. The wells 208 are arranged in such microtitre plates in particular in a regular pattern, wherein the pattern can vary for different microtitre plates.

FIG. 2C also illustrates schematically a sample carrier 106 with a plurality of typically closed sample chambers 210, also called chamber slides. Also for this type of sample carrier 106, the localization 202 of the sample is approximately congruent with the respective sample chamber 210. The different sample carriers 106 illustrated in FIGS. 2A to 2C are only an exemplary selection of sample carriers 106 possibly used in experiments. The person skilled in the art knows the different usually used sample carriers 106 as well as the respective localization 202 of the samples in the respective sample carriers 106.

Even if the sample carriers 106 illustrated in FIG. 2B and FIG. 2C have no label 206, these sample carriers 106 can also have one or more labels 206, but the labels 206 have been omitted for these sample carriers 106 on account of the better clarity. In particular, each of the wells 208 or each of the sample chambers 210 can be provided with a respective label 206, such that the respective well 208 or the respective sample chamber 210 can be identified by means of a label 206 based on the respective label 206. In particular, the labels 206 can comprise context information, for example encoded in the barcodes, the QR codes or by handwritten inscriptions.

The image data evaluation system 1 is in particular designed to record overview images 300 of the sample carriers 106 in order to determine the localization 202 of one or more samples in the respective sample carrier 106 on the basis of the overview images 300. Structures 312 which are caused by elements of the sample holding device are formed in the overview images 300 of samples held in the sample holding device.

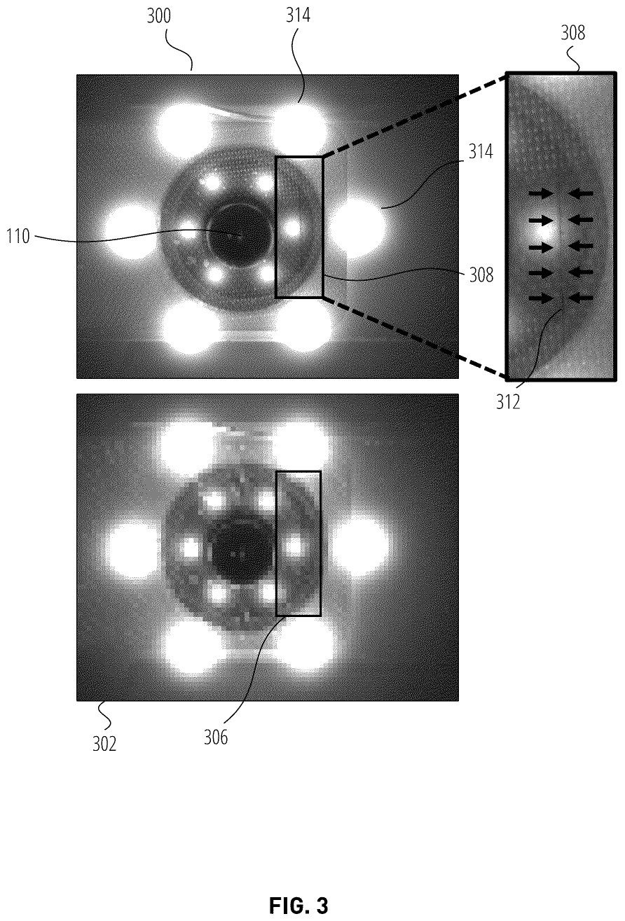

By way of example, FIG. 3 shows such an overview image 300 recorded with an overview camera 110. Six light spots 314 can be identified in the overview image 300. The light spots 314 are caused by an illumination arrangement of the overview camera 110, which light spots are reflected on the glass surface of the sample carrier 106 and are thus detected by the overview camera 110 in the overview image 300. Depending for example on a geometry of the overview camera 110, also in relation to the illumination arrangement, the geometry of the sample holding device, the relative arrangement of the sample holding device to the overview camera 110 or the geometry of the optics of the overview camera 110 and the respective arrangement for example of sample holding device, sample carrier 106 and overview camera 110 or camera of the microscope 100 with respect to one another, specific elements of the sample holding device can bring about the structures 312 in the case of a specific arrangement relative to the overview camera 110. The structures 312, also called image artefacts, will bring about spherical or chromatic properties of the elements in particular by casting shadows, reflection, refraction or diffraction. The structures 312 or image artefacts can comprise in particular light or dark lines, light or dark arcs, circular arcs or circles, so-called blobs, particularly light or dark image areas, so-called spots, distortions, mirroring, doubling or the like.

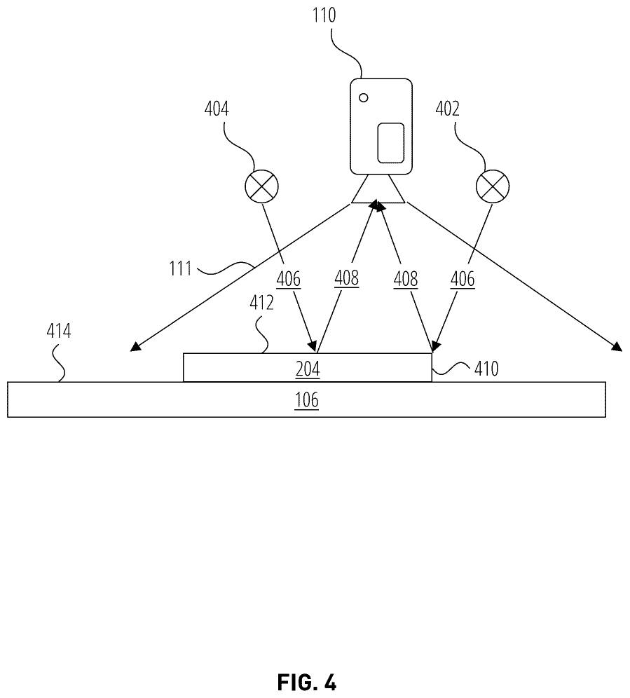

By way of example, the emergence of the structures 312 is described below with reference to the schematic drawing in FIG. 4, which illustrates a schematic side view of the arrangement with which the overview image 300 illustrated in FIG. 3 was recorded. In this example, the overview camera 110 has an illumination arrangement comprising a plurality of LEDs, wherein only a first LED 402 and a second LED 404 are illustrated in the illustrated side view. The overview camera 110 is arranged above a glass surface of the sample holding device, wherein the glass surface comprises a glass surface 414 of the sample carrier 106 and a glass surface 412 of the cover glass 204.

The overview camera 110 has the indicated field of view 111 and records the overview image 300 of the sample carrier 106 including the cover glass 204 in the field of view 111. In this example, the first LED 402 of the illumination arrangement of the overview camera 110 is arranged relative to the overview camera 110 and the sample holding device comprising at least the sample carrier 106 and the cover glass 204 in such a way that light 406 emitted by the first LED 402 strikes an edge 410 of the cover glass 204 in such a way that the structure 312 can be identified as a dark line in the overview image 300 capturing the reflected light 408, see also FIG. 3 in this regard. The light 406 emitted by the second LED 404 is reflected by the glass surface 412 of the cover glass 204 facing the overview camera 110 in such a way that the reflected light 408 of the second LED 404 captured by the overview camera 110 in the overview image 300 just does not form a structure 312 in the overview image 300.

Instead, the above-described reflections of the illumination arrangement of the overview camera 110 and, in an exemplary manner, of the sample carriers 106 are visible.

According to the embodiment illustrated in FIG. 3 and FIG. 4, the overview camera 110 comprises an illumination arrangement; in this geometry, the emergence of the structures 312 can be explained particularly illustratively. The person skilled in the art knows many different forms of overview cameras 110, in particular FIG. 1 shows a further alternative in which the overview camera 110 looks at the sample via the mirror 112 on the objective turret 102. In such an embodiment, in which the overview camera 110 comprises, for example, no illumination arrangement arranged around the overview camera 110, the overview image 300 has in particular no light spots 314, or the camera cannot be identified on the overview image 300. The person skilled in the art knows the different designs of overview cameras 110 and corresponding illumination arrangements and knows how the corresponding overview images 300 appear. These can differ quite considerably from the arrangements illustrated in FIG. 3 and FIG. 4.

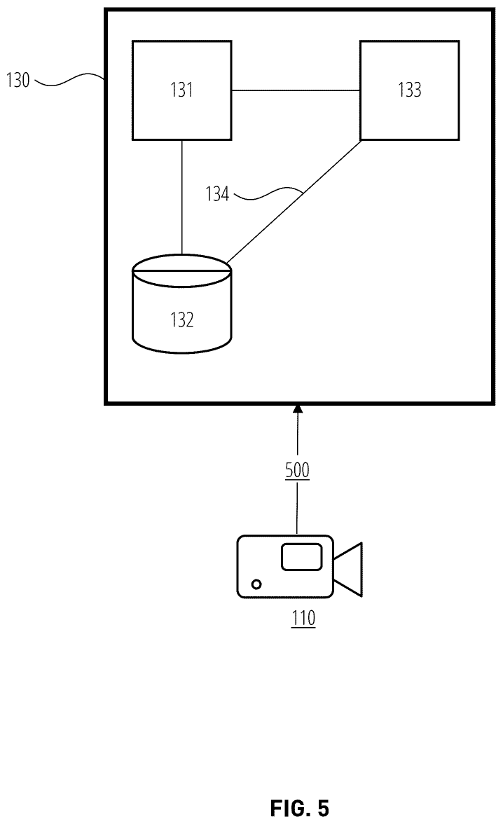

According to this embodiment, the control apparatus 130, as illustrated schematically in FIG. 1, is connected to the monitor 120. The control apparatus 130 is configured to control the microscope 100 to record image data 500 using the microscope camera 107 or the overview camera 110, to evaluate the recorded image data 500 using an evaluation module 131 and to store the image data 500 on a memory module 132 (see FIG. 5) of the control apparatus 130.

The recorded image data 500 can be displayed on the monitor 120 if necessary. The control apparatus 130 is configured to process or evaluate the recorded image data 500. The image data 500 comprise in particular the overview images 300, but can also comprise microscope images recorded with the microscope camera 107.

The control apparatus 130 comprises not only the evaluation module 131 and the memory module 132 but also the control module 133. The modules of the control apparatus 130 are connected to one another via channels 134, wherein they can exchange data with one another via the channels 134. The channels 134 are logical data connections between the individual modules. The modules can be designed both as software modules and as hardware modules.

The evaluation module 131 evaluates the input image data 500 and, based on the evaluation, forwards information to the control module 133 or forwards the results of the evaluation to the memory module 132 for storage.

The memory module 132 stores the image data 500 recorded by the microscope 100 and manages the data to be evaluated in the control apparatus 130.

The control module 133 can read out image data 500 from the memory module 132 and forward them to the evaluation module 131 for evaluation. In addition, the control module 133 can send control or steering commands, also called control information, to the microscope 100. In particular, the control module 133 can be configured to generate the control information based on the information obtained from the evaluation module 131.

In this case, the control information can control the microscope 100 overall or only certain parts. In particular, the control information can comprise information about a position, also called localization 202, of a sample in the sample holding device, which has been determined with the evaluation module 131. Alternatively, the control module 133 can send control information for determining the localization of the sample in the sample holding device to the microscope 100.

According to the present embodiment, the image data evaluation system 1 is designed to determine a localization 202 of the sample in the sample holding device. In particular, the localization 202 of the sample is determined on the basis of image data 500 recorded with the overview camera 110. Alternatively, the microscope camera 107 can also be used for recording an overview image 300. In this case, an objective 103 with as small a magnification as possible is used so that as many components of the sample holding device as possible are visible in the overview image. The overview image 300 can then be processed as image data 500.

In particular, the evaluation module 131 can comprise one or more machine learning models 600. In particular, the machine learning models 600 are implemented as neural networks. According to one configuration, the evaluation module 131 comprises one or more processing models which are not machine learning models 600.

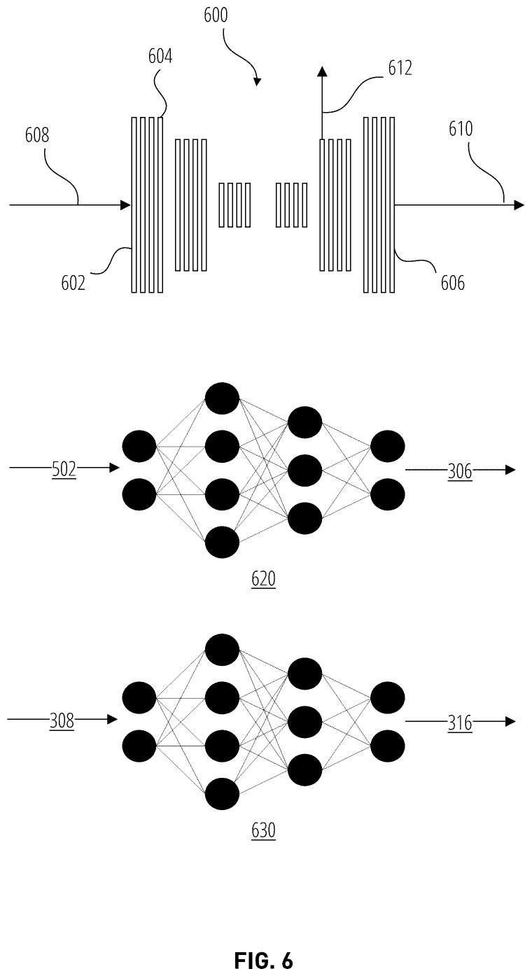

The different processing models are in particular machine learning models 600. A machine learning model 600 (see FIG. 6) can be, in particular, a neural network with a plurality of layers. In particular, the machine learning model 600 has an input layer 602, one or more intermediate layers 604 and an output layer 606. The input layer 602 receives an input datum 608, processes the input datum 608 by means of the input layer 302, the intermediate layers 604 and the output layer 606 and outputs a result datum 610. Depending on which type or implementation of processing model is used, the form and extent of the input data 608 and of the result class 310 vary. For some machine learning models 600, intermediate data 612 can also be output.

In the sense of the present invention, an “input layer” is a first layer of a machine learning model with a plurality of layers, in particular a first layer of a neural network.

The machine learning models 600 can be implemented in particular as regressors, classifiers, segmentation models or else image-to-image models.

In the sense of the present invention, a “regressor”, also called regression model, is a processing model, in particular a machine learning model, which carries out a regression. If the regressor is a machine learning model, it is trained to carry out the regression, in particular by supervised learning or unsupervised learning. The regressor then respectively outputs as result datum a probability that the input datum is a structure region.

In the sense of the present invention, “supervised learning” is a learning process in which a machine learning model for executing a desired mapping is trained by means of an annotated data set.

In the sense of the present invention, “unsupervised learning” of a machine learning model is training or learning in which training is carried out solely on the basis of a non-annotated data set without the specification of a desired target, wherein the machine learning model automatically finds or should find specific clustering points in the data set.

Independently of an implementation, the machine learning models 600 must be trained in a training for executing a processing mapping. During training of the machine learning model 600, the evaluation module 131, controlled by the control module 133, reads some of the image data 500 of a training data set, wherein the training data set is in particular an annotated data set, from the memory module 132 and inputs training data into the respective machine learning model 600. The evaluation module 131 determines an objective function on the basis of the output data or the result data 610 of the machine learning model 600 and, based on target data contained in the annotated data set, and optimizes the objective function by adapting the model parameters of the machine learning model 600 based on the optimization of the objective function.

In particular, the optimization of the objective function is carried out by means of a stochastic gradient descent method. In the stochastic gradient descent method, only a small subset of the training data of the annotated data set, referred to as batch, is used in each case. For each input datum 608 of the batch, based on result datum 610 output by the machine learning model 600 and the target datum of the annotated data set corresponding to the input datum 608, the control module 133 determines the objective function, here a loss function, which captures a difference between the output datum 240 and the target datum. Thereafter, the control module 133 calculates a gradient for each of the calculated objective functions with respect to the model parameters of the machine learning model 600, sums the calculated gradients over the batch and determines the mean value. From the mean value, the control module 133 determines updated model parameters for the machine learning model 600 by so-called back propagation. The machine learning model 600 is newly initiated by the control module 133 with the updated model parameters in the evaluation module 131 and a next step of the stochastic gradient descent method is carried out.

The training of the machine learning model 600 aborts as soon as it is achieved by the optimization of the objective function that the objective function reaches a predetermined threshold value.

Once the training has been completed, the control module 133 stores the most recently used model parameters of the machine learning model 600 in the memory module 132, in particular together with context information, such that the machine learning model 600 just trained can be identified again later and can be initialized, for example, for further training or the inference.

As an alternative to the stochastic gradient descent method, other methods can also be used.

In particular, any other training method can be used.

Once the training of a machine learning model 600 is ended, the corresponding model parameters are stored in the memory module 132 and can be read out later in the inference for executing the learned processing mapping.

According to some embodiments of the present invention, in particular machine learning models 600 are used which are implemented as classifier, detector or segmentation model. Furthermore, two different machine learning models 600 are used which are each trained with different training data sets for carrying out a processing mapping. In particular a selection model 620 and an identification model 630.

The selection model 620 is configured to identify structure regions 306 in coarse image data 502. The input data 608 of the selection model 620 are the coarse image data 502 and the result data 610 are the structure regions 306, or the structure regions 306 can be determined based on the result data 610.

The identification model 630 is configured to determine structure information 316 in the image data 500. The input data 608 of the identification model 630 are structure regions 308 of the image data 500, just now. The identification model 630 is configured to determine the structure information 316, wherein the result data 610 each depend on a type of the implementation.

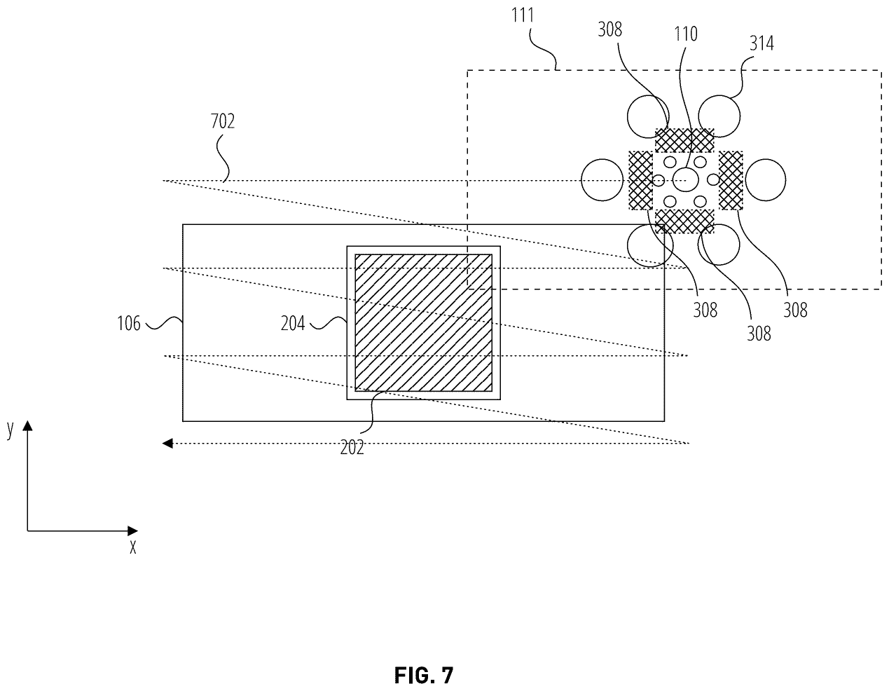

A method for determining a localization 202 of a sample in a sample holding device is described below with reference to FIGS. 7 to 11.

In particular, hardware-based solutions for determining a localization 202 of a sample in a sample holding device are known from the prior art. For this purpose, use is made, in particular, of special illumination devices which serve to make structures 312 generated by certain components of the sample holding device, see, for example, FIG. 3, more visible in image data 500, in particular by virtue of the illumination devices improving an image contrast. This type of illumination device is expensive, not available or applicable for each microscope type and furthermore the results achieved therewith are often flawed, for which reason the customer acceptance is low. All software-based solutions known hitherto in the prior art have extremely high demands on the computational hardware, are very time-consuming and still suffer from quality problems for this purpose.

In the described method for determining the localization 202 of a sample on the basis of structure information, first image data 500 are provided in a step S1. According to this embodiment, the providing of the image data 500 comprises recording of one or more overview images 300 with the overview camera 110. In the overview image 300, the overview camera 110 at least partially captures the sample holding device or the elements thereof, in particular also the sample carrier 106. The elements can in particular be one or more of: the holding frame 105, the sample carrier 106, the sample stage 104, but furthermore also the cover glass 204 with which the sample is covered on the sample carrier 106, a spacer which is provided between the sample carrier 106 and the cover glass 204. The elements or the regions of the elements of the sample holding device captured in the overview image 300 cause structures 312 in the image data 500. The structures 312 caused can be in particular edges, as can be seen in FIG. 3, blobs, textures, characters, shadows or the like. An example of the image data 500 is illustrated in particular in FIG. 3.

For better understanding, FIG. 7 schematically shows the recording of a plurality of overview images 300 with an overview camera 110. In this case, the overview camera 110 detects objects which are located within the field of view 111 of the overview camera 110. The field of view 111 thus corresponds just to the detail which is captured in the overview image 300 by the overview camera 110. By way of example, the hatched areas are drawn in here; if elements of the sample holding device are located within the hatched areas, these can cause structures 312 in the respective overview image 300, which is why the hatched areas correspond just to the structure regions 308. The hatched areas are drawn in here only by way of example; the actual distribution of the structure regions 308 can also depend on the orientation of the elements of the sample holding device with respect to one another.

The overview path 702 drawn in in FIG. 7 indicates a possible relative movement of the overview camera 110 via the sample holding device. In this case, it is irrelevant whether the overview camera 110 or the sample holding device is movable or both; the overview path 702 is indicated here merely for better understanding. If one of the areas drawn in as possible structure regions 308 is arranged, for example, above the cover glass 204, a structure 312 is formed in the overview image 300. As a result of the movement of the overview camera 110 relative to the sample holding device, the entire sample holding device can be scanned, such that, in the case of a suitably selected overview path 702, all edges 410 have been scanned once and captured as structure 312 in one of the overview images 300. The relative position of the sample holding device and of the overview camera 110 with respect to one another is also captured in each case for each of the recorded overview images 300.

According to one configuration, the image data 500 of the overview images 300 are provided directly with coordinate information during storage; the coordinate information can be converted, in particular, into coordinates in a rest coordinate system of the sample holding device, such that identical objects in the overview image 300 always have the same coordinates. Alternatively, it is also possible to select other coordinate systems; however, the choice of the rest coordinate system of the sample holding device has the advantage that objects in the overview images 300 are always assigned the same coordinates, which is why they can be identified more easily and structure regions 308 of different overview images 300 can be compared, combined or merged more easily. Depending on an accuracy of a drive of the movable parts of the microscope, different overview images 300 also have to be registered to one another; for this purpose, in particular edges, blobs or similar image details visible in a plurality of overview images 300, in particular stationary relative to the sample holding device, can be used.

In particular, steps for registering image data 500 of different images to one another can be carried out during the entire method.

According to one configuration of the first embodiment, the overview image 300 can also be recorded with the microscope camera 107. If the microscope camera 107 is used for recording the overview image 300, the microscope 100 must be set or used such that it uses an objective 103 with as small a magnification as possible, for example 1-fold, 1.5-fold, 2-fold, or 3-fold to 5-fold, during the recording of the overview image 300.

According to a further configuration of the first embodiment, the image data 500 comprises a plurality of overview images 300 captured with a camera, wherein during the recording of the overview images 300 a position of the camera is varied relative to a position of the sample holding device, or the position of the sample holding device is varied with respect to the position of the respective camera, so that in each case different parts of the sample holding device are captured at different locations in the overview images 300. In particular, the relative positions of the sample holding device to the respectively used camera are in each case stored together with the image data 500 for all overview images 300.

According to a further configuration of the first embodiment, instead of the overview image, the image data 500 can also comprise a sequence of images, an image stack comprising a plurality of images offset in height with respect to one another, a stereo image, an image with depth information or one or more of the images described above with a low contrast.

The inventors have recognized that the image regions in which the structures 312 caused by the elements of the sample holding device are always similar relative to further image contents surrounding the structures 312 in the overview image 300. The image contents surrounding the structures 312 are also called the surroundings of the structures 312, and the image regions in which the structures 312 are usually visible are called structure regions below. An example of such a surroundings and the position of the structure regions 308 is already described above with reference to FIG. 3. In FIG. 3, the reflections of the illumination arrangement and of the overview camera 110 precisely form the surroundings, as described with reference to FIG. 4, for example the structures 312 caused by the cover glasses 204 are visible just when, as described above, they are arranged relative to the first LED 402 and to the overview camera 110. Furthermore, the inventors have recognized that image information or image details necessary for the identification of the structure regions 308 about the surroundings of the structure regions 308 are also still contained in a coarse overview image 302 reduced in detail compared to the overview image 300.

Therefore, according to the first embodiment, step S1 is followed by step S2 determining coarse image data 502, based on the image data 500. The coarse image data 502 are reduced in detail compared to the image data 500. The detail reduction can be achieved in that, in particular, a bit depth with which colors and/or intensities are captured is reduced, in that a number of pixels is reduced, in that a sampling is reduced, in that, in particular if the image data 500 comprise image stacks, only some of the images offset in height of the image stack are transferred into the coarse image data 502. According to a further configuration, an image format used by the respective camera can in particular be an image format with a progressive image compression.

If the coarse image data 502 were stored by means of a progressive image compression, a determination of the coarse image data 502 would correspond precisely to a selection of a partial data set corresponding to a desired compression or a desired degree of reduction in detail.

According to this embodiment, the image data 500 are precisely the overview images 300 and the coarse image data 502 are precisely the coarse overview images 302, as illustrated by way of example in FIG. 3. As described, the coarse overview image 302 reduced in detail is determined from the overview image 300, which has fewer pixels compared to the overview image 300.

According to a step S3, the coarse image data 502 are used to determine, by means of the selection model 620, structure regions 306 based on the coarse image data 502.

The inventors have recognized that the coarse overview image 302 reduced in detail still comprises a sufficient number of details in order to train the selection model 620 for determining the structure regions 306, provided that the reduction in detail is just selected during the selection of the coarse image data 502 such that the image contents, image information or image details making up the surroundings of the structure regions 306 are still recognizable in the coarse image data 502. Due to the fact that the coarse image data 502 comprise fewer details than the image data 500, the selection model 620 does not have to co-learn the fine image structures present in the image data 500, instead the selection model learns the relative position of the structure regions 306, for example, to the light spots 314 in the surroundings of the structure regions 306. As already described further above, the light spots 314 are only mentioned here by way of example, the surroundings of the structure regions 306 can also have quite different structures significantly different from the spots 314. If in particular a different illumination of the sample is selected, the overview image 300 changes correspondingly.

If the image data 500 were to be evaluated by the selection model instead of the coarse image data 502, the selection model would have to learn a lot more details, in particular all details of the surroundings of the structure regions 306, which is why the model would have to be more complex and an extent of a training data set would have to be significantly larger. However, since the coarse image data 502 reduced in detail already contains the required information or the required image details, a data efficiency during the training as well as in the inference can be considerably improved by the reduction in detail and the computational effort in the inference can thus also be considerably reduced.

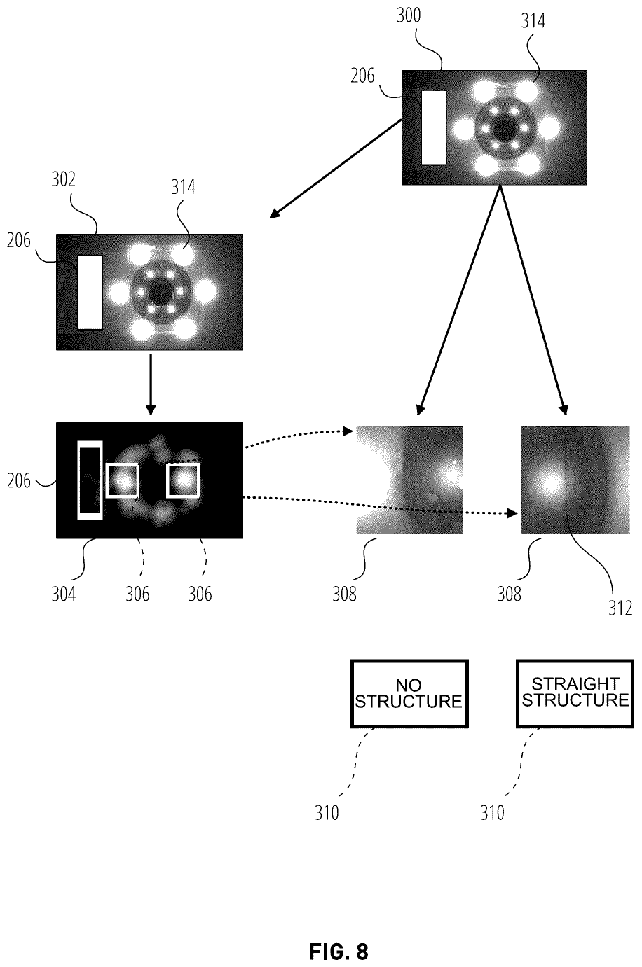

According to the method, in the inference the coarse image data 502 are input into the selection model 620 implemented in the evaluation module 131. The selection model is a machine learning model 600, as illustrated, for example, in FIG. 6. According to the first embodiment, the selection model 620 is implemented as image-to-image model and outputs a probability map 304 in which a probability is assigned to each entry of the coarse image data 502 that the respective entry captures a structure 312. In the probability map 304 shown, the lighter regions are precisely the regions which capture a structure 312 with a high probability. In the output probability map 304, the structure regions 306 of the coarse image data 502 are determined on the basis of the probability values in the probability map 304. In this case, the determining of the structure regions 306 is not necessarily carried out directly by the selection model, but rather, as in the example shown, by suitably selecting the image regions in the probability map 304 with probability values above the certain probability. As shown, for example, by selecting rectangular image regions from the probability map 304 in which the probability values lie above the certain probability. A structure region 306 is then precisely the white-bordered image region of the coarse overview image 302, as illustrated by way of example in FIG. 8. Alternatively, however, all image regions with probability values above the certain probability can also simply be selected and corresponding image regions or data regions of the image data 500 can be further processed.

According to one configuration, the selection model 620 can alternatively also be implemented as classifier, detector or as segmentation model.

If the selection model 620 is implemented according to one of the abovementioned alternatives, the input data 608 respectively input into the selection model 620 and the result data 610 output by the selection model 620 possibly differ from the input data 608 and result data 610 of the image-to-image model, but in principle the respective result data 610 in turn allow a determination of the structure regions 306.

According to the first embodiment, step S3 is followed by step S4 determining, by means of an identification model 630, the structure information based on the structure regions 306.

According to the first embodiment, the structure regions 308 of the image data 500 corresponding to the structure regions 306 of the coarse image data 502 are input into the identification model 630. The identification model is implemented in particular as classifier.

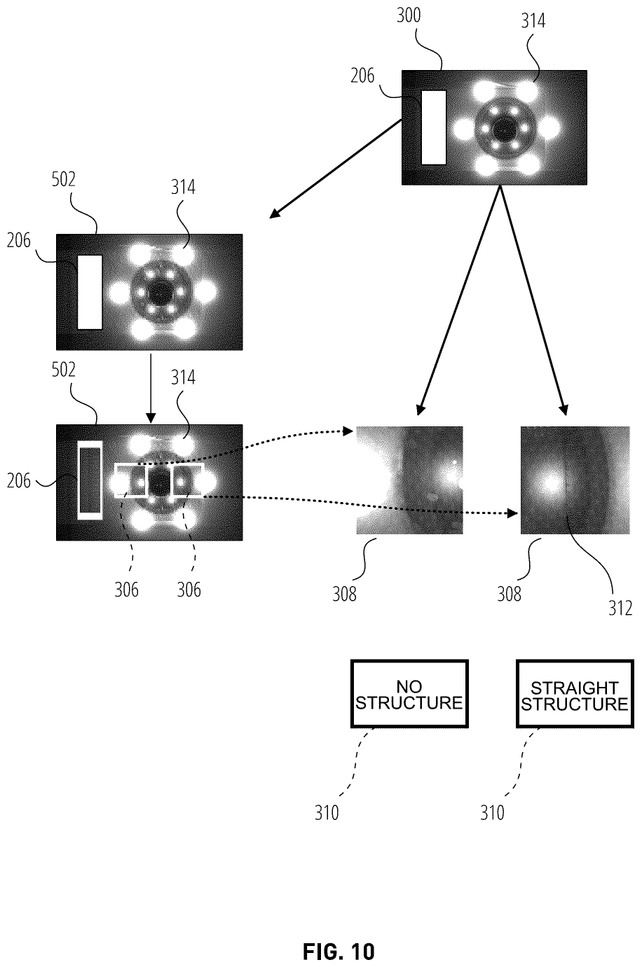

The identification model 630 determines a shape class in the input structure regions 308 according to the embodiments illustrated in FIG. 8 and FIG. 10, which shape class indicates whether a structure 312 can be identified or not in the structure region 308 and, if a structure 312 can be identified, which type the structure 312 is. As illustrated for example in FIG. 8 and FIG. 3, the structure 312 is an edge 410, in particular a cover glass edge of a straight cover glass 204, that is to say the result class 310 for the structure region 308 illustrated on the right is the form class “straight cover glass edge” or alternatively, depending on the number of differently used form classes, only “straight structure”. For the structure region 308 shown on the left, the shape class “no structure” is output. Depending on the elements of the sample holding device used, the form classes to be identified can also comprise other forms of structures 312, in particular round structures. The shape classes in particular can comprise: no structure, structure, round structure, straight structure, polygonal structure, straight cover glass edge, polygonal cover glass edge, round cover glass edge, sample carrier edge, spacer structure, holding frame structure, Microtiter plate edge structure, Microtiter plate well structure, sample chamber edge structure, sample chamber structure, alternatively also only round, polygonal, square, rectangular, straight, round, oval, no shape or no structure.

If the image data 500 comprise a plurality of overview images 300, the shape classes are in each case determined for all overview images 300 and all structure regions 308. The position of the respective structure region 308 in the respective overview image 300 and the position of the sample holding device relative to the overview camera 110 are in each case also stored as structure information 316 for each particular shape class. In particular, as described above, a coordinate in the rest coordinate system of the sample holding device can also be directly assigned to each of the image pixels of the overview images 300.

According to the first embodiment, step S4 is followed by step S5 determining a localization 202 of the sample, based on the structure information. According to the first embodiment, the structure information comprises the shape classes output by the identification model implemented as classifier and the respective position in the rest coordinate system, wherein a position, for example a center point, is in each case used as position here for the respective structure region 308. According to the example illustrated in FIG. 8, the identification model finds in the one illustrated overview image 300 precisely an edge 410, in this example a straight cover glass edge, the shape class of the structure region 308 illustrated on the right in FIG. 8 is correspondingly “straight structure”. In the case of a suitably selected overview path 702, further edges 410 are found in further structure regions 308.

In particular, the edge 410 of the cover glass 204 which generates the structure 312 illustrated in FIG. 8 in the overview image 300 can also cause a structure 312 in further overview images 300. If the same element of the sample holding device, here for example the edge 410 of the cover glass 204, generates structures 312 in a plurality of overview images 300, then these plurality of structures 312 according to some embodiments of the present invention are also referred to as source-identical structures and the structure regions in which the source-identical structures are captured are source-identical structure regions. Depending on an image quality, it can occur that the identification model 630 determines different form classes for structures of identical origin. Therefore, step S5 for source-identical structure regions in particular also comprises a step of merging structure information 316. In the sense of the present invention, structures in overview images are “source-identical” if they are caused by the same element of the sample holding device.

The merging of structure information 316 in particular comprises determining the source-identical structure regions, for this purpose the positions of the structure regions in the rest coordinate system of the sample holding device are determined and, based on the positions and the respective extents of the structure regions 306, it is determined whether the structure regions at least partially overlap. If this is the case, the structure regions 306 are further processed as originally identical structure regions 306.

When merging the structure information 316, in particular a majority decision can be taken. If, for example, the source-identical structure regions comprise structure regions 308 of six different overview images 300 and four of the result data 310 of the identification model 630, that is to say here the respectively assigned shape class “straight structure”, match, as shown by way of example in FIG. 8, and two of the result data 310 are different from the others, the assigned shape class for the source-identical structure regions is “straight structure” according to the majority decision.

According to one configuration of the embodiment, an orientation of the structure regions 308 can be taken into account when determining the source-identical structure regions. For example, in the case of a square cover glass 204, two structure regions can overlap at one of the corners, even if the structures 312 captured in the structure regions 308 are not caused by the same edges 410. In particular, an edge can be aligned vertically and an edge can be aligned horizontally. An orientation of the structure regions 308 can be used in particular to determine whether structure regions 308 are of identical origin or not, structure regions 308 with different orientation can then be treated as not of identical origin. However, according to a further configuration, corners can instead also be treated as of identical origin. In particular, the identification model 630 can then output “polygonal structure” as shape class for such corners.

In addition to the source-identical structure regions, structures 312 which are caused by different elements of the sample holding device can also occur in overview images 300. For example, each of the four edges 410 of a cover glass 204 can cause a structure 312 in one or more overview images 300. If the four edges 410 are identified, the result is the localization 202 of the sample, as outlined in FIG. 7, to the square area within the found edges 410. For this type of sample carriers 106 with only one cover glass 204, it is possible, in the case of a total of four found edges 410, for example by determining a centroid from the found edges 410, to find a center of the sample. The extent of the sample and thus the localization 202 can then be determined from the respective distance of the edges 410 to one another or also from the center.

In particular, however, the localization 202 of the sample can also be determined only on the basis of an edge as lying somewhere in the region of the edge. As a result of the identification of an individual edge 410 of the cover glass 204, a localization 202 of the sample, compared with an entire overview image, is already restricted to such an extent that the sample can then also be found, for example, by means of a regular microscope camera 107.

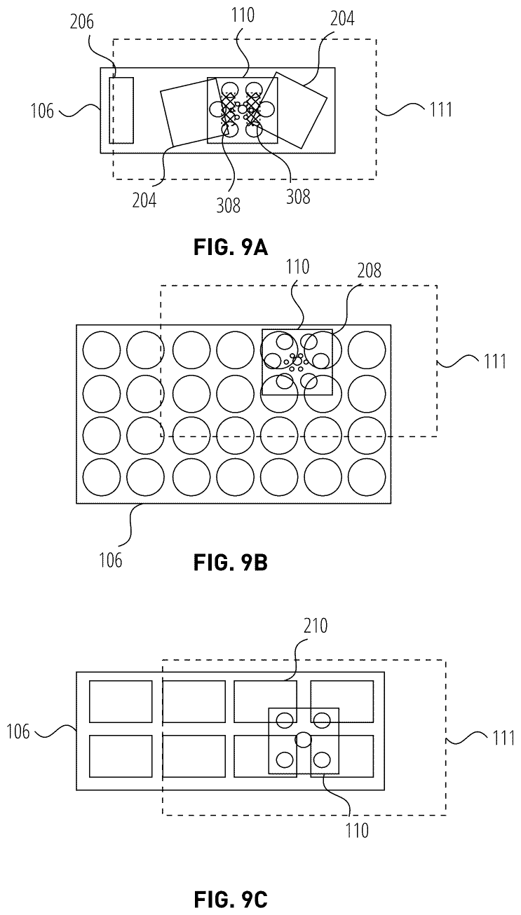

A further configuration is illustrated with reference to FIG. 9A. The illustrated sample carrier 106 corresponds to the sample carrier 106 from FIG. 2A. In the schematic drawing, the field of view 111 of the overview camera 110 is drawn in by dashed lines, objects within the field of view 111 are visible in the overview image 300 with good illumination of the field of view 111. In the example illustrated, the structure regions 306 within the field of view 111 are illustrated with a crossed filling. According to the illustration, from a cover glass 204 illustrated on the right, the lower left-hand tip would just fall into the structure region 306 and should be visible in the overview image 300, from the cover glass 204 illustrated on the left, a part of the right-hand edge would just fall into the structure region 306 and would be visible in the overview image 300. According to this configuration, for example, in addition to the shape class, an angle could also be determined by which the cover glasses 204 are rotated out of the horizontal. For sample carriers 106 with a plurality of cover glasses 204, the localization 202 is determined for each cover glass 204, wherein, when determining the localization 202, the angle by which the respective cover glass 204 is rotated, i.e. an orientation of the cover glass 204, is taken into account.

A further configuration of the first embodiment is shown in FIG. 9B. The illustrated sample carrier 106 corresponds to the sample carrier 106 from FIG. 2B. As described above with reference to FIG. 9A, a field of view 111 of an overview camera 110 is also drawn in here again. Since the sample carrier 106 used is a microtitre plate, according to this configuration the corresponding structures 312 must be identified for a certain number of the wells 208. In particular, for example, the individual wells 208 can respectively be identified based on the edge. Alternatively, it may also be sufficient if an outer row of the regularly arranged wells 208 is identified along a first direction, for example in the x-direction, and an outer row of the regularly arranged wells 208 is identified in the y-direction, in particular in each case the outer wells and a distance of the individual wells 208. For the sake of clarity, the structure regions 308 are not drawn in in this illustration, as described above, they depend on the imaging device 100 used.

As already described above with reference to the first embodiment, according to one configuration, when using a sample carrier 106 which comprises a microtitre plate, an overview path 702 can be adapted after the identification of a well 208, for example the overview path 702, such that firstly the regular pattern of the wells 208 is determined and then the outer edge of the pattern, or vice versa, and, if the outer edge is found, the extent along the pattern can be determined particularly rapidly. For this purpose, for example, the pattern can be suitably scanned once along the outer edge in a vertical and in a horizontal direction.

A further configuration of the first embodiment is illustrated in FIG. 9C. The sample carrier 106 corresponds to the sample carrier 106 from FIG. 2C and comprises a plurality of sample chambers 210. In this configuration, the overview camera 110 is different from the preceding configurations, but this schematic illustration should also not be regarded as limiting. The person skilled in the art knows the different embodiments of overview cameras 110 and their respective illumination arrangement. As already with reference to the microtitre plates, for identifying the individual sample chambers 210 when finding suitable structures 312, it is also possible for patterns and edges to be suitably determined again; in order to optimize the overview path 702 for the most efficient possible determination of the localization.

FIG. 10 shows a further configuration of the first embodiment. According to the illustrated configuration, the selection model is implemented as classifier. The classifier outputs an assigned class in each case for various input image regions or data regions of the coarse image data 502 as result datum 610. The selection model is each configured to determine structure regions 306 in the coarse image data 502. Accordingly, the assigned classes comprise at least one class which is assigned to the structure regions 306, the so-called structure class, and a class which indicates that the respective data region is not a structure region, the so-called non-structure class. Further classes which the selection model 620 implemented as classifier can identify, for example, would be a further class for image regions comprising labels 206, a so-called label class, and a further class for image regions in which no sample is reliably captured, a so-called non-sample class. The classifier can in turn be configured in different ways.

According to one configuration, the classes identified by the classifier can comprise a class for label 206. Identified labels 206 can then in particular be read out using a label readout model in order to determine context information. However, the position of the labels 206 can also be used, for example, in determining the localization 202.

For a so-called patch classifier, a so-called sliding window function respectively selects data regions, in particular successively neighboring data regions, from the coarse image data 502 and inputs the selected data region into the patch classifier. For the embodiment described here, the sliding window function would respectively select a rectangular or also square image section from the overview image and input it into the patch classifier. The patch classifier respectively outputs the result class found for the input data region, here the image section, that is to say whether the image section is a structure region 306 or not. The sliding window function now successively selects data regions such that, at the end, all of the coarse image data 502 are input into the patch classifier, and the patch classifier assigns or has assigned a class to each of the input data regions. Correspondingly, for the data regions white-bordered in FIG. 10, the patch classifier outputs that the data regions are structure regions 306. In particular, the data regions selected by the sliding window function can be disjunct or overlapping. If overlapping data regions are used, then the white-bordered data regions can be selected by means of a non-maximum suppression function from possibly a plurality of overlapping data regions which the patch classifier assigns structure region 306 to the class, so that the structure region 308 is forwarded only once to the identification model 630.

According to a modification, the classifier can also be a modified regular classifier, referred to here as map classifier. The map classifier is implemented as convolutional neural network (CNN), wherein the network architecture is modified such that a final pooling layer of the CNN is omitted. In the pooling layer, the outputs of the preceding layers of the CNN are combined in order, for example, to combine the intermediate outputs of the preceding layers, in particular different feature maps, to form a result output. The overview image 300 is respectively input as a whole into the map classifier, and the map classifier outputs a spatially resolved classification map as result datum by omitting the last pooling layer. A class is assigned to various partial regions of the coarse image data 502 in the classification map, in each case spatially resolved, which indicates whether the respective partial region is a structure region 306 or not, or a class corresponding to the classes described above.

If the selection model 620 is instead the segmentation model, then the segmentation model outputs a segmentation mask as result datum 610. A result class is assigned to each entry of the coarse image data 502 in the segmentation mask corresponding to the classes described above. Accordingly, the result datum 610 consists, for example, of a bit map in which a “1” entry is assigned, for example, to each entry which the segmentation model has assigned as belonging to a structure region, in particular because the respective entry captures a structure 312 generated by an element of the sample holding device in the image data with a certain probability, and a “0” entry is assigned to an entry which does not belong to a structure region 306. Coherent regions of the coarse image data 502 are correspondingly identified or further treated as structure regions 306. Alternatively, more than 2 different classes can also be assigned; in particular, one class could still be assigned for labels 206 found. In the case of specific occurring structures 312, the selection model 620 can possibly directly identify that it is a non-sample region in the overview image 300, which is then assigned correspondingly to a non-sample class.

According to one configuration of the first embodiment, the identification model can also output an element class as result datum 610. Here, an element class can in particular correspond to each of the possible different elements of the sample holding device, the result datum 610 then just indicates to which element of the sample holding device the respectively captured structure 312 corresponds.

In particular, the identification model can be implemented such that it has two different output paths, wherein one of the output paths outputs the element class and the other of the output paths outputs the element shape.

In particular, specific machine learning models 600, so-called element-specific machine learning models 600, can also be respectively stored for each of the possible elements of the sample holding device, for different sample holding devices, different sample carriers 106 or for different microscope types, both for the selection model 620 and for the identification model 630. The respective specific machine learning model 600 then respectively outputs corresponding result data according to the occurring structures 312.

According to a further configuration, the identification model 630 can distinguish between different designs of different ones of the element classes. If, for example, the element of the sample holding device causing the structures 312 is a cover glass, then the identification model 630 can have been trained to distinguish different cover glass shapes and cover glass sizes from one another. For example round and polygonal cover glasses and cover glass sizes different for each shape, for example 2, 3, 4 or 5 different cover glass sizes. The identification model 630 can then in particular have been designed and trained such that it outputs a cover glass shape, i.e. round, polygonal or no structure found, and a cover glass size for each structure region 306. For this type of identification model 630, the shape class then comprises not only the pure shape class “round”, “polygonal”, “no structure” but also a size class.

Correspondingly, corresponding identification models 630 can be provided in each case for other elements, which identification models are designed correspondingly for identifying the element shape and the element size. In particular, a shape class can be provided for each combination of element shape and element size.

In particular, a shape class can also be implemented in each case for each element, each element shape and each element size as possible class to be assigned by the identification model. Based on the result datum 610, it is therefore possible not only to determine a shape of the respective structure, as illustrated in FIG. 8 and FIG. 10, but also to determine from which element of the sample holding device the respectively classified structure 312 originates and which element size has caused the classified structure 312.

According to one configuration of the first embodiment, however, the identification model can also be designed as segmentation model. The result datum is then a segmentation mask for each input structure region 308, in which segmentation mask a class is assigned to each entry. In particular, the assigned class can be one of the classes described above with reference to the identification model implemented as classifier. Alternatively, however, the segmenter can also be configured to assign a class from “structure found” and “no structure found” to each entry. The segmentation masks thus produced can then be analyzed in the step S5 following step S4 to the effect where the sample is located, based on the respectively identified structures 312.

According to a further configuration of the first embodiment, the identification model can also be implemented as image-to-image model. The result datum of the image-to-image model is then a probability map in which a probability is assigned to each entry of the input datum to find a structure 312 at the respective point. The output probability map can in turn be used for localizing the sample. According to a further modification, the result datum comprises a probability distribution over the different result classes for each entry. Like result classes, these are precisely the shape classes described above with reference to the identification model 630 implemented as classifier.

According to the first embodiment, steps S1 to S5 are carried out correspondingly one after the other. According to a modification of the first embodiment, however, other sequences of the steps described above are also possible. Some modifications are outlined below which show how, for example, the steps S1 to S5 can still be combined.

For example, firstly according to step S2, the coarse image data can be determined, in particular by recording a coarse overview image 302. Thereafter, step S3 determines the structure regions 306. On the basis of the structure regions 306, the image data 500 are then recorded, in particular with the microscope camera 107 with an objective 103 with as small a magnification as possible.

For example, for each overview image 300 recorded on the overview path 702 described above in step S1, steps S2 to S5 can respectively be carried out, wherein, in particular, if structure regions 306 or structures 312 were identified in one of the steps, the overview path is suitably adapted in order to configure the overview path 702 as efficiently as possible. This can in particular comprise the fact that more overview images 300 are recorded after the identification of an edge 410 of a cover glass 204, in particular in the vicinity of the identified edge 410. If, for example, non-sample structure regions are identified in an overview image 300, the position of sample holding device and overview camera 110 is adapted such that these non-sample structure regions are not captured where possible or captured as little as possible in the overview images.

According to a further embodiment, the merging of the source-identical structure regions 306 can take place based on the probability maps output by the selection model 620, wherein the source-identical structure regions 308 are sorted according to the probability values in the structure regions 308 and then processed by the identification model 630 such that first the structure regions 308 with higher probability values are processed in the respective structure regions 308, wherein a processing aborts as soon as the identification model 630 outputs an unambiguous result. An unambiguous result in the sense of the present invention is in particular a result according to which a structure 312 has been identified, that is to say that a structure 312 is unambiguously identified according to the result output of the identification model 630, for example by majority decision. Alternatively, the merging can abort after the analysis of a predetermined number of k originally identical structure regions 308, in particular if the k originally identical structure regions are the structure regions with the highest probability values.

According to a further embodiment, the merging of the structure information 316 can be carried out by means of an overarching statistical model. In the overarching statistical model, the result datum output by the identification model 630 implemented as image-to-image model, in which result datum a probability distribution over the possible result classes is assigned to each entry, is respectively input into the statistical model as input. Based on the probability distributions determined for the respective structure region 308, it can then be determined by means of the statistical model which type of structure 312 is involved.

According to a further embodiment, when merging the structure information 316 for the source-identical structure regions 308, the result data output by an identification model 630 implemented as segmentation model, i.e. the segmentation masks, are processed by a localization model implemented as classifier. The localization model then in turn outputs a shape class as result datum on the basis of the input segmentation masks.

According to a further configuration, the recording of a single overview image 300 is sufficient to determine the localization. In particular, this can be the case if precisely as many structures 312 can be identified in an overview image 300 that the position of the sample can be unambiguously determined. This is the case in particular if, for example, a sample carrier 106 with a cover glass 204 is used, the dimensions of which are known. If, for example, a corner in a structure region 308 is then identified, or, for example, a circular arc, the sample can be unambiguously localized. The same applies, for example, to other types of sample carriers 106, in particular if, in particular, only certain types or designs of sample carriers 106 or sample holding devices are used in certain microscopes 100.

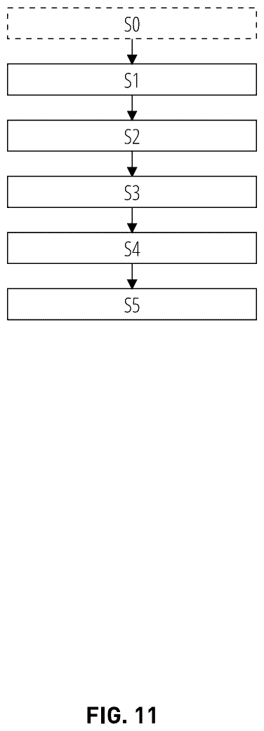

FIG. 11 schematically shows a flowchart of the method according to the first embodiment. A step S0 is drawn in here as optional. Step S0 comprises training the selection model 620 and the identification model 630. An annotated data set is determined for training the selection model 620. In this case, the determining comprises the recording of image data 500, in particular one or more overview images 300, wherein the image data 500 are initially not reduced in detail. In the recorded image data 500 not reduced in detail, the structures 312 are then identified, for example, with classic image processing methods. If the structures 312 are identified, target data are determined, wherein the exact form of the target data, as described above, depends on the implementation of the respective selection model 620. If the target data are determined, the image data 500 are reduced in detail, as described above with reference to the coarse image data 502 reduced in detail. Thereafter, the target data are also correspondingly determined for the coarse image data 502. Thereupon, the coarse image data 502 can be used together with the target data as annotated data set for training for the selection model 620.

For training the identification model 630, the training data set comprises corresponding target data, in each case depending on the implementation, as described above with reference to the different configurations of the identification model 630. In particular, the structure regions 308 are respectively annotated correspondingly here.

The training of the machine learning models 600 can be respectively specially trained, for example, for different configurations of different types or construction types of sample holding devices, imaging devices 100 or image data evaluation systems 1. Accordingly, when evaluating the image data 500, a respective machine learning model 600 can be selected according to the respective configuration.

According to one configuration, the overview path 702 is not, as shown, a predefined path, but is selected randomly, or is selected according to certain statistical criteria such that structures 312 can be localized as far as possible with a high probability. In particular after the finding of a first structure 312, based on a shape of the structure, a next point on the overview path is selected, for example at an end of the first structure found.

According to a second embodiment, after step S5, the method further comprises a step S6 for controlling the imaging device for capturing a sample, based on the localization of the sample, wherein the capturing here means in particular the automatic capturing of the sample, the imaging device 100 is currently being controlled such that images are captured of the entire sample.

According to a third embodiment, a control apparatus 130 having means for carrying out the method according to the first to third embodiments is provided.

According to a fourth embodiment, a computer program product is provided which comprises instructions which, when the program is executed by one or more computers, cause the latter to carry out the method according to the embodiments described above.

With a fifth embodiment, an image data evaluation system 1 is provided, comprising the control apparatus 130 according to the third embodiment. The image data evaluation system 1 comprises in particular a microscope.

With a sixth embodiment, a microscope 100 is provided which is configured to carry out the method according to the first and second embodiments.

The variants and configurations described with reference to the different figures can be combined with one another. The configurations shown and described are purely illustrative and modifications thereof are possible within the scope of the appended claims.

1. Method for determining a localization of a sample, based on structure information, wherein elements of a sample holding device holding the sample in an imaging device form structures in image data captured with the imaging device, comprising:
providing of the image data,
determining, by means of a selection model, structure regions based on coarse image data,
determining, by means of an identification model, the structure information based on the structure regions, and
determining a localization of the sample, based on the structure information, wherein:
the coarse image data is reduced in detail compared to the image data, the structure regions are regions in the image data in which the structures are captured with a certain probability, and a sum of data amounts of the structure regions is smaller than the data amount of the image data.

2. The method according to claim 1, wherein the image data comprises in particular images captured by a camera of the imaging device, and in particular comprises one or more of the following:
a plurality of images, wherein in particular during the capturing of at least one pair of the plurality of images a relative position of a used camera to the sample holding device differs from one another,
one or more temporal sequences of image stacks,
a stereo image,
an image with depth information,
an image with a low contrast, or
an image captured with an objective with a small magnification.

3. The method according to claim 1, wherein the coarse image data exhibits in particular one or more of the following over the image data:
a lower sampling depth,
a lower image resolution,
a lower temporal resolution, or
a lower resolution along a height, in particular a greater distance of neighboring images of a stack.

4. The method according to claim 1, wherein the sample holding device comprises one or more elements, in particular holding frame, slide, cover glass, spacer, sample carrier, holding frame, inscriptions, markings or labels, and structures of the sample holding device captured in the image data are visible in particular as light or dark lines, light or dark arcs, circular arcs or circles, so-called blobs, particularly light or dark image areas, so-called spots, distortions, mirroring, doubling, textures or characters.

5. The method according to claim 1, further comprising:
determining coarse image data based on the image data, and in particular
determining structure regions in the coarse image data, and
selecting the structure regions of the image data corresponding to the structure regions of the coarse image data, wherein the structure regions corresponding to one another capture the same elements of the sample holding device.

6. The method according to claim 1, wherein the selection model is a machine learning model implemented as classifier, detector, segmentation model or image-to-image model, and the determining of the structure regions comprises:
inputting at least one partial region of the coarse image data as input data into the selection model,
outputting a result datum, and in particular
selecting the structure regions from the image data based on the result datum.

7. The method according to claim 6, wherein the selection model is configured as image-to-image model, wherein the result datum is a probability map in which a probability value is assigned to entries of the input datum, which indicates the probability with which the respective entry captures a structure, in particular to each entry or respectively to a group of entries, and the determining of the structure regions comprises a grouping of entries of the image data based on the probability, in particular continuous entries of the coarse image data form a structure region with probability values above the certain probability.

8. The method according to claim 7, wherein the determining of the structure information comprises inputting the structure regions of the image data into the identification model according to an order, the order is determined based on the probability values of the structure regions, in particular structure regions with higher probability values are classified in the order before structure regions with lower probability values and the inputting of the structure regions in particular aborts as soon as certain numbers of structure information have been determined or only a predetermined number of the structure regions with the highest corresponding probability values are input into the identification model and the further structure regions with lower probability values are no longer input into the identification model.

9. The method according to claim 1, wherein the identification model is implemented as classifier, segmentation model, detector or as image-to-image model.

10. The method according to claim 9, wherein the identification model is implemented as a segmentation model and the result datum comprises a segmentation mask of the respective structure region, in which a shape class is assigned to each entry of the input datum, and the structure information is determined based on the segmentation mask, the shape classes in particular comprise one or more of the following classes: no structure, structure, round structure, straight structure, polygonal structure, straight cover glass edge, polygonal cover glass edge, round cover glass edge, sample carrier edge, spacer structure, holding frame structure, Microtiter plate edge structure, Microtiter plate well structure, sample chamber edge structure, sample chamber structure.

11. The method according to claim 10, wherein the determining of the structure information is performed based on the segmentation mask, wherein a mask classifier determines a shape class based on the segmentation mask, and certain of the structure information is assigned to the shape class.

12. The method according to claim 10, wherein the result data output for the different structure regions is merged with the remaining image data to form reduced-detail result data, the respective result data being assigned to the structure regions, and the value of the non-structure shape class being assigned to the entries of the remaining image data, and the localization being determined based on the reduced-detail result data.

13. The method according to claim 9, wherein the identification model is configured as image-to-image model, wherein a value is assigned to each entry of the input datum in the result datum, which indicates whether the respective entry captures a structure or not, wherein the value in particular is a probability, and in particular the result datum is a probability map.

14. The method according to claim 1, wherein the determining of the localization comprises merging structure information from a plurality of source-identical structure regions from different overview images, wherein one or more structures which have each been caused by the same element of the sample holding device are captured in the source-identical structure regions.

15. A method for controlling an imaging device for capturing a sample, based on a localization of a sample, wherein the localization has been determined according to claim 1, the method further comprising:
controlling the imaging device, based on the determined localization.

16. A method for training a selection model for determining object regions based on coarse image data, wherein the selection model is in particular trained for carrying out the method according to claim 1, comprising:
providing of image data,
determining structure regions in the image data,
determining coarse image data reduced in detail compared to the image data,
determining object regions corresponding to the structure regions,
providing the coarse image data as input data and target data, on the basis of which the structure regions can be identified, as annotated data set for training the selection model.

17. A control apparatus for controlling an image data evaluation system, which is in particular designed as a microscope, comprising means for carrying out the method according to claim 1.

18. An imaging device, in particular designed as a microscope, comprising a control apparatus according to claim 17.

19. An image data evaluation system comprising at least one imaging device according to claim 18.

20. A computer program product comprising instructions which, when the program is executed by one or more computers, cause the latter to carry out the method according to claim 1.
